(19) United States
(12) Patent Application Publication
(10) Pub. No.: US 2012/0020445 A1
(43) Pub. Date: Jan. 26, 2012

(54) Wireless sensor synchronization methods

(76) Inventors: Stephen J. DiStasi, Colchester, VT (US); Christopher P. Townsend, Shelburne, VT (US); Jacob H. Galbreath, Burlington, VT (US); Steven W. Arms, Shelborne, VT (US)

(21) Appl. No.: 13/004,843

(22) Filed: Jan. 11, 2011

Related U.S. Application Data
(60) Provisional application No. 61/293,948, filed on Jan. 11, 2010.

(51) Int. Cl. H04W 56/00

(52) U.S. Cl. 375/355

(57) ABSTRACT

A method of sampling data includes providing a plurality of wireless nodes, wherein each of the wireless nodes includes a receiver, a real time clock and a counter. Ticks of the real time clock are counted by the counter. The method also includes broadcasting a common beacon for receipt by receivers of each of the wireless nodes, and upon receipt of the common beacon setting each of the counters to a first preset value.

### PRIORITY

This application claims the benefit of U.S. Provisional Patent Application 61/293,948, filed Jan. 11, 2010, “Wireless sensor synchronization methods,” incorporated herein by reference.

### RELATED PAPERS

This application is related to the following publications, all of which are incorporated herein by reference:
1. Arms, S. W., Townsend, C. P., Galbreath, J. H., Churchill, D. L, Phan, N., “Synchronized System for Wireless Sensing, RFID, Data Aggregation, & Remote Reporting”, American Helicopter Society 65^{th} Annual Forum, Grapevine, Tex., to be published May 29-31, 2009
2. Arms, S. W., Townsend, C. P., Churchill, D. L., Galbreath, J. H., Corneau, B, Ketcham, R. P., Phan, R., “Energy Harvesting, Wireless, Structural Health Monitoring and Reporting System”, 2nd Asia-Pacific Workshop on SHM, Melbourne, Dec. 2-4, 2008
3. S. W. Arms, J. H. Galbreath, C. P. Townsend, D. L. Churchill, B. Corneau, R. P. Ketcham, Nam Phan, “Energy Harvesting Wireless Sensors and Networked Timing Synchronization for Aircraft Structural Health Monitoring,” to be published in the conference proceedings of the First International Conference on Wireless Communications, Vehicular Technology, Information Theory and Aerospace & Electronic Systems Technology (Wireless VITAE), May 17-20, 2009, Aalborg Congress and Culture Centre, Aalborg, Denmark
4. “WSDA®-Base-mXRS™ Wireless Base Station Technical Product Overview,” MicroStrain, Inc., Williston Vt., 2010
5. Extended Range Synchronized (mXRS™ Wireless Sensing System FAQs, MicroStrain, Inc., Williston Vt., 6 Dec. 2010

### RELATED PATENTS AND PATENT APPLICATIONS

This application is also related to the following patents and patent applications, all of which are incorporated herein by reference:
1. U.S. Pat. No. 3,695,096 Strain detecting load cell
2. U.S. Pat. No. 4,283,941 Double shear beam strain gauge load cell
3. U.S. Pat. No. 4,364,280 Double shear beam strain gauge load cell
4. U.S. Pat. No. 7,188,535 Load cell having strain gauges of arbitrary location
5. U.S. Pat. No. 6,629,446 Single vector calibration system for multi-axis load cells and method for calibrating a multi-axis load cell
6. U.S. Pat. No. 7,170,201 Energy harvesting for wireless sensor operation and data transmission
7. U.S. Pat. No. 7,081,693 Energy harvesting for wireless sensor operation and data transmission
8. U.S. Pat. No. 7,143,004 Solid state orientation sensor with 360 degree measurement capability
9. U.S. Pat. No. 6,871,413 Miniaturized inclinometer for angle measurement with accurate measurement indicator
10. U.S. Pat. No. 6,529,127 System for remote powering and communication with a network of addressable, multichannel sensing modules
11. U.S. Pat. No. 5,887,351 Inclined plate 360 degree absolute angle sensor
12. 20050146220 Energy harvesting for wireless sensor operation and data transmission
13. 20050140212 Energy harvesting for wireless sensor operation and data transmission
14. 20050116545 Energy harvesting for wireless sensor operation and data transmission
15. 20050116544 Energy harvesting for wireless sensor operation and data transmission
16. 20050105231 Energy harvesting for wireless sensor operation and data transmission
17. 20040078662 Energy harvesting for wireless sensor operation and data transmission
18. 20060103534 Identifying substantially related objects in a wireless sensor network
19. Ser. No. 09/731,066 Data Collection and Storage Device (Attorney Docket number 1024-034)
20. Ser. No. 09/768,858 & Ser. No. 10/215,752 (divisional) Micropower Differential Sensor Measurement (Attorney Docket number 1024-037)
21. U.S. Pat. No. 7,256,505 Shaft mounted energy harvesting for wireless sensor operation and data transmission (attorney docket number 115-014), (“the '505 patent”)
22. Ser. No. 11/084,541 Wireless Sensor System (attorney docket number 115-016)
23. Ser. No. 11/091,244 Strain Gauge with Moisture Barrier and Self-Testing Circuit (attorney docket number 115-017), (“the '244 application”)
24. Ser. No. 11/260,837 Identifying substantially related objects in a wireless sensor network (attorney docket number 115-018)
25. Ser. Nos. 11/368,731 and 60/659,338 Miniature Acoustic Stimulating and Sensing System, (attorney docket nos. 115-019 & 115-028)
26. Ser. No. 11/604,117, Slotted Beam Piezoelectric Composite Structure, (attorney docket number 115-022), (“the '117 application”)
27. Ser. No. 11/585,059, Structural damage detection and analysis system (attorney docket number 115-036)
28. Ser. No. 11/518,777, Energy Harvesting Wireless Structural Health Monitoring System (attorney docket number 115-030)
29. 60/898,160 Wideband Energy Harvester, (attorney docket number 115-052)
30. 60/497,171 A Capacitive Discharge Energy Harvesting Converter (attorney docket number 115-051)
31. Ser. No. 12/360,111, “Independently Calibrated Wireless Structural Load Sensor,” docket number 115-059, filed Jan. 26, 2009 (“the '111 application.”).
32. 61/169,309, “Wind Turbines and Other Rotating Structures,” filed Apr. 15, 2009, (attorney docket number 115-067)
33. 61/179,336, “Component RFID Tag with Non-Volatile Display of Component Use,” filed May 18, 2009, (attorney docket number 115-068)

### REFERENCES

This application is also related to the following reference publications, all of which are incorporated herein by reference:
1. Selvam, K., “Individual Pitch Control for Large Scale Wind Turbines, Multivariable Control Approach”, Masters Thesis, Energy Research Center of the Netherlands, TU Delft, ECN-E-07-053, Jul. 25, 2007.
2. van der Hooft, E., P. Schaak and van Engelen, T., “Wind turbine control algorithm. Report ECN-C-03-111, ECN, 2003.
3. van Engelen, T., “Design Model and Load Reduction Assessment for Multi-rotational Mode Individual Pitch Control (Higher Harmonics Control)”, European Wind Energy Conference. Athens, Greece, 2006.
4. van Engelen, T., “Control design based on aero-hydro-servo-elastic linear models from TURBU”, European Wind Energy Conference, Milano, Italy, 2007.
5. van Engelen, T. and Van der Hooft, E., “Individual Pitch Control Inventory”, Report ECN-C-03-138, ECN, 2003.

### FIELD

This patent application generally relates to a system for monitoring wireless nodes. It also relates to a system of sensor devices and networks of sensor devices with wireless communication links. More particularly it relates to a system for monitoring sensor nodes that transmitting data wirelessly and for providing for the time of sensor sampling.

### BACKGROUND

Wireless sensor nodes have been used to monitor sensors on a network. However, time for sensor sampling has been difficult to accurately determine and control, and this problem is addressed by the following description.

### SUMMARY

One aspect of the present patent application is a method of sampling data. The method includes providing a plurality of wireless nodes, wherein each of the wireless nodes includes a receiver, a real time clock and a counter. Ticks of the real time clock are counted by the counter. The method also includes broadcasting a common beacon for receipt by receivers of each of the wireless nodes, and upon receipt of the common beacon setting each of the counters to a first preset value.

Another aspect of the present patent application is a method of performing an action. The method includes providing a plurality of wireless nodes, wherein each of the wireless nodes includes a receiver and a real time clock. The method also includes broadcasting a common beacon and synchronizing the real time clocks in each of the wireless nodes based on the beacon. The method also includes simultaneously performing an action by each of the wireless nodes wherein timing in each wireless node is determined by the synchronized real time clock.

### BRIEF DESCRIPTION OF THE DRAWINGS

FIG. 1 is a block diagram illustrating the components and connections in a wireless sensor node;

FIG. 2 illustrates a timing diagram showing three wireless sensor nodes with synchronized sampling in which pulses represent the time for sensor measurements;

FIG. 3 illustrates an oscilloscope trace showing three wireless sensor nodes marking the start of a sample on each of the three sensors;

FIG. 4 illustrates an oscilloscope trace showing three wireless sensor nodes marking the start of a sample pulses from each of the three nodes that were collected over one hour using the persistent graphing mode of a multi-channel oscilloscope, thus creating a drift envelope; and

FIG. 5 illustrates an oscilloscope trace showing three sensors operating in a synchronized network while utilizing a TDMA transmission scheme in which the shorter duration spikes represent sensor samples occurring at 256 Hz while the longer duration pulses represent transmissions.

### DETAILED DESCRIPTION

The present applicants found a method of simultaneously performing an action by a plurality of wireless nodes, such as taking data with a sensor, in which each of the wireless nodes includes a receiver, a real time clock and a counter. The real time clock has an output that is a waveform, such as a square wave shape. Ticks of the real time clock, each of which is one complete square wave, are counted by the counter. A common beacon is broadcast for receipt by receivers of each of the wireless nodes. Upon receipt of the common beacon each of the counters is reset to a first preset value. This effectively synchronizes the real time clocks so that when the counter reaches a preset value for the action, the action is taken by all the wireless sensor nodes at the same time.

### Wireless Sensor Node

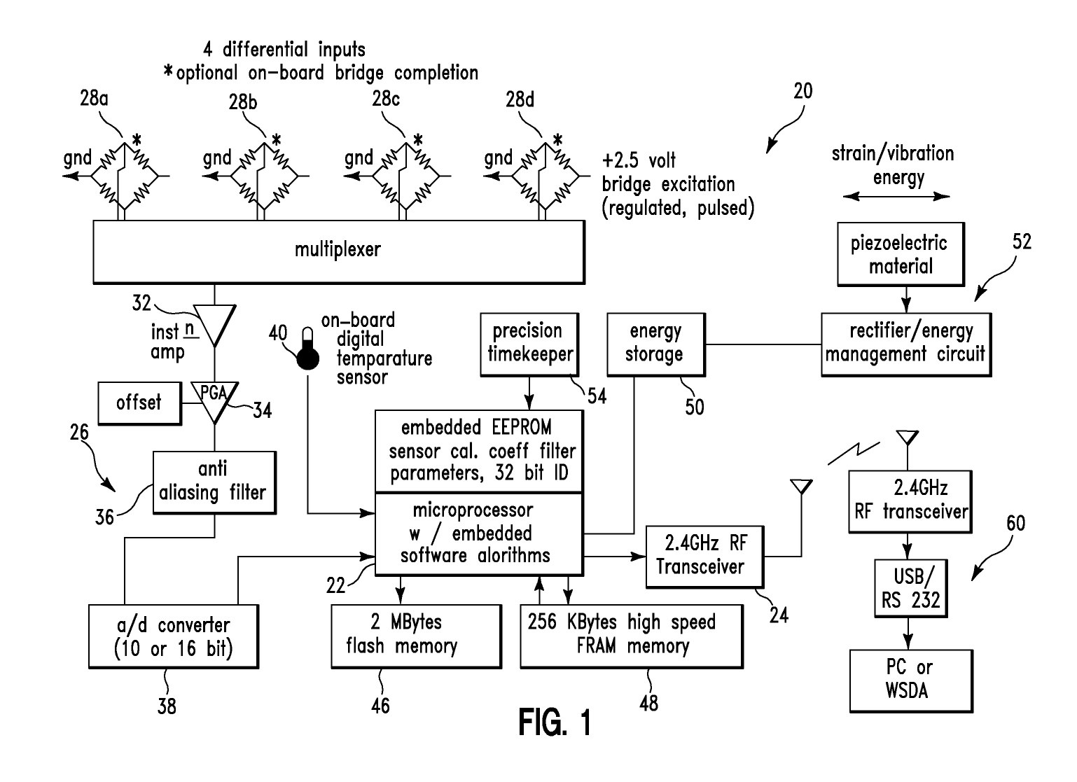

In one experiment, each wireless sensor node 20 included microcontroller 22 connected to 2.4 GHz transceiver chip 24 and sensor signal chain 26, as shown in the block diagram of FIG. 1. One or more sensors 28a-28d were attached to sensor signal chain 26, which included circuitry such as multiplexer 30, instrumentation amplifier 32, gain amplifier with offset adjust 34, anti-aliasing filter 36, and 16-bit analog to digital converter 38. Onboard digital temperature sensor 40 was connected to microprocessor 22. Memory, such as 2 MB of non-volatile memory 46, 48, was also connected to microcontroller 22. A power source, such as battery 50 or energy harvesting device 52 was connected to power all the components. Precision time keeper 54 was also connected to microcontroller 22.

A PIC 18F4620 microcontroller from Microchip, Inc. and transceiver chip CC2420 from Texas Instruments, Inc., and RTC DS3234 from Maxim Integrated Products were used.

Embedded firmware within each node was programmed to support the following features:

Wireless data transmission

Data logging to non-volatile memory

Up to 4 multiplexed sensor channels which support wide array of Wheatstone bridge type sensors

10, 12, or 16-bit analog to digital conversion

Synchronized sampling within +/−30 microseconds (theoretical worst case is +/−60 us using 20 second resynchronization rate)

Programmable sampling rate 32 to 512 Hz

Buffered transmissions for power conservation

Base stations respond with acknowledgment

Automatic retransmission of dropped data packets

TDMA transmission scheduling

### Sensor Timing

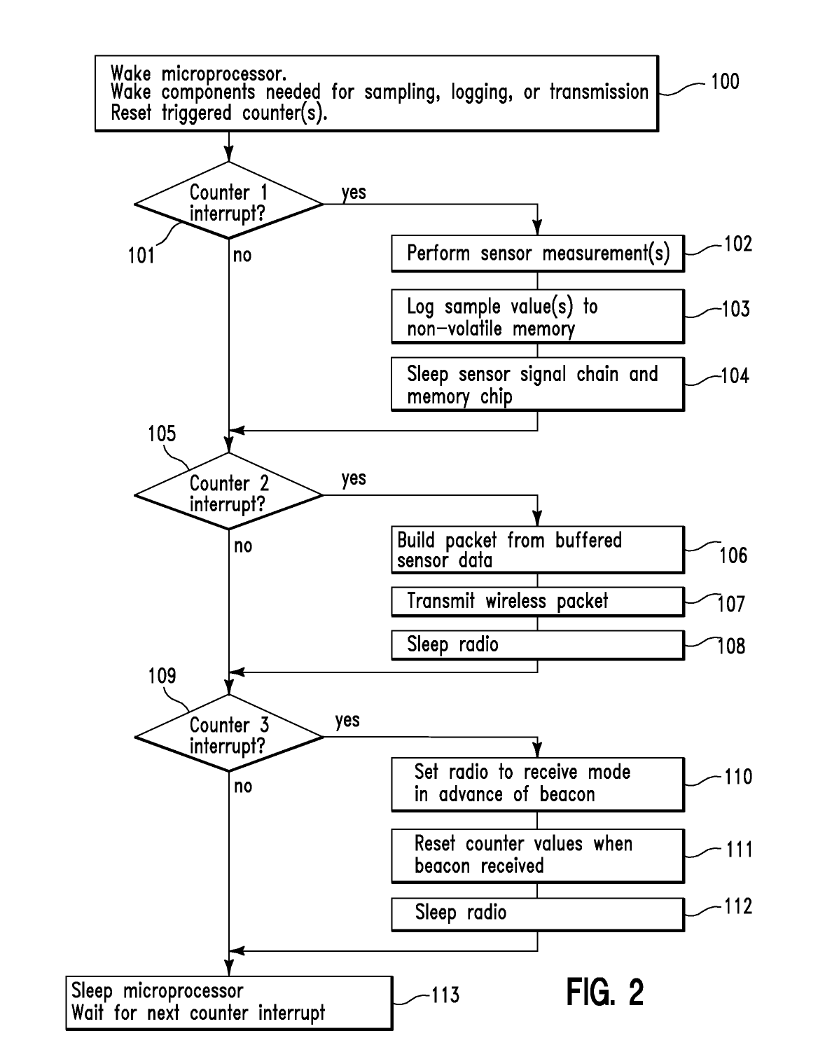

In one embodiment, each wireless sensor node includes a high precision, temperature compensated timekeeper, such as a real-time clock (RTC), and a microcontroller that includes a counter. The output of this RTC is directly linked to an input port on the microcontroller. The RTC ticks at regular intervals, and each RTC tick is counted by the counter in the microcontroller so that actions may be performed at specific preset values of this counter. In this way, actions such as wake-up the microcontroller from sleep mode, sample a sensor, and transmit data with a transmitter may occur at controlled preset times or time intervals, as shown in the flow chart in FIG. 2.

In operation, the RTC provides ticks to counter 1 that determines time for sensor measurements, counter 2 that determines time for transmitting data, and counter 3 that sets the radio into receive mode in advance of the beacon. When one of these counters reaches a preset value it sends an interrupt signal that wakes microprocessor 22 from sleep mode, wakes components needed for sampling and logging or transmission, and resets the respective counter, as shown in box 100.

If counter 1 provided the interrupt, then microprocessor 22 directs performing sensor measurements and logging data to non-volatile memory, as shown in boxes 101 to 103. Then microprocessor 22 directs sensor signal chain and memory chips to sleep mode, as shown in box 104.

If counter 2 provided the interrupt, then microprocessor 22 directs building a packet from the logged sensor data in non-volatile memory and causes transceiver 24 to transmit the data, as shown in boxes 105 to 107. Then microprocessor 22 directs transceiver 24 to sleep mode as shown in box 108.

If counter 3 provided the interrupt, then microprocessor 22 sets transceiver 24 to receive mode in advance of receipt of the beacon and resets all counter values when the beacon is received, as shown in boxes 109 to 111. Then microprocessor 22 directs transceiver 24 to sleep mode as shown in box 112.

Then microprocessor 22 enters sleep mode until the next counter interrupt signal arrives, as shown in box 113.

In the experiment, the RTC ticked at 32 kHz and the present applicants sampled the sensor at 256 Hz. This sampling rate required the sensor to sample every 32,768/256=128 ticks of the RTC. Thus, the preset value for the counter in the microcontroller was 128 ticks more than its starting value.

An RTC running at a higher frequency can be used, and this would provide greater time resolution and allow greater synchronization of the actions performed by the wireless sensor nodes, for example, from a given broadcast starting signal. However, running a clock at higher speed uses more power and for some applications where there is a desire to minimize power consumption, a slower RTC may therefore be desired.

This patent application also provides ways to improve synchronization for a given RTC frequency. For example, it allows improved synchronization of the actions on the various wireless nodes in which each is running a slower RTC and in which a secondary clock is used in each wireless sensor node to provide offset compensation, as further described herein below.

Sensor sampling, data transmissions, and other actions often occur at separate rates. For example, sampling of data with a sensor may occur far more frequently than transmission of that data. The timing for performing an action, such as taking data from a sensor, is accomplished by keeping track of the number of ticks of the RTC, as collected by the counter and comparing to a preset value. For performing more than one action, such as collecting data and transmitting, more than one preset value may be used.

For example, in the sensor node described above for which we wish to sample 256 times per second, the user may want to transmit data only 4 times a second. In this case we would set a sample-counter to reset every 128 ticks of the RTC to provide sampling at a rate of 256 times per second. In one embodiment we would set a transmit-counter to provide transmission after every 64 samples of data are recorded.

Additional counters can also used to schedule other actions at other rates.

### Beacon and Sensor Synchronization

A common beacon signal is used to synchronize sensor samples and schedule transmissions between discrete sensor nodes. In one embodiment, this beacon is broadcast every second by a device, such as a base station unit 60, as shown in FIG. 1, or a designated wireless sensor node. The beacon occurs at a designated counter value, and the wireless sensor nodes all adjust their own counters to equal the designated value when the beacon is received. For example, the designated value may be at counter value=20. Wireless sensor nodes will listen for the beacon broadcast, and when it is discovered, each wireless sensor node will adjust its own counter value to 20.

The counter memory location in each wireless sensor node is thus adjusted to the same designated value when the beacon is received and this counter memory location gets updated by one unit with every tick of the RTC in that node and continues to be updated by one unit with each subsequent tick. Because the beacon has synchronized all the counters, and because the RTCs are all ticking at about the same rate, actions of each wireless sensor node based on its own RTC and its own counter will be synchronized with actions in all the other wireless sensor nodes. Any drift because of differences in RTC rate is again corrected when the next beacon is received.

### Drift

The RTC present on each sensor node has a given tolerance, which represents the maximum drift of its clock relative to the clocks on other sensor nodes. For example, an RTC with tolerance +/−3 parts per million will exhibit a maximum drift of +/−3 micro seconds every second.

Illustrating the magnitude of drift without frequent periodic synchronization, a test was conducted. With the time synchronization beacon sent only at the onset of the two hour long test, and with exposure to temperatures of −40 to +85 degrees C., the system's timing accuracy was found to be ˜5 milliseconds.

To prevent sensor sampling in the different wireless sensor nodes from drifting so far apart, one embodiment of this patent application provides that all the wireless sensor nodes re-synchronize to the beacon. Beacon resynchronization rate can be changed according to needs of the user. Less time between beacons improves synchronization, and more time between beacons saves power.

### Accuracy of Synchronization

The sensor nodes can only adjust their timing if their counter has drifted by 1 or more RTC ticks. This gives them a best case synchronization resolution of the time between ticks or +/−1/(RTC output frequency).

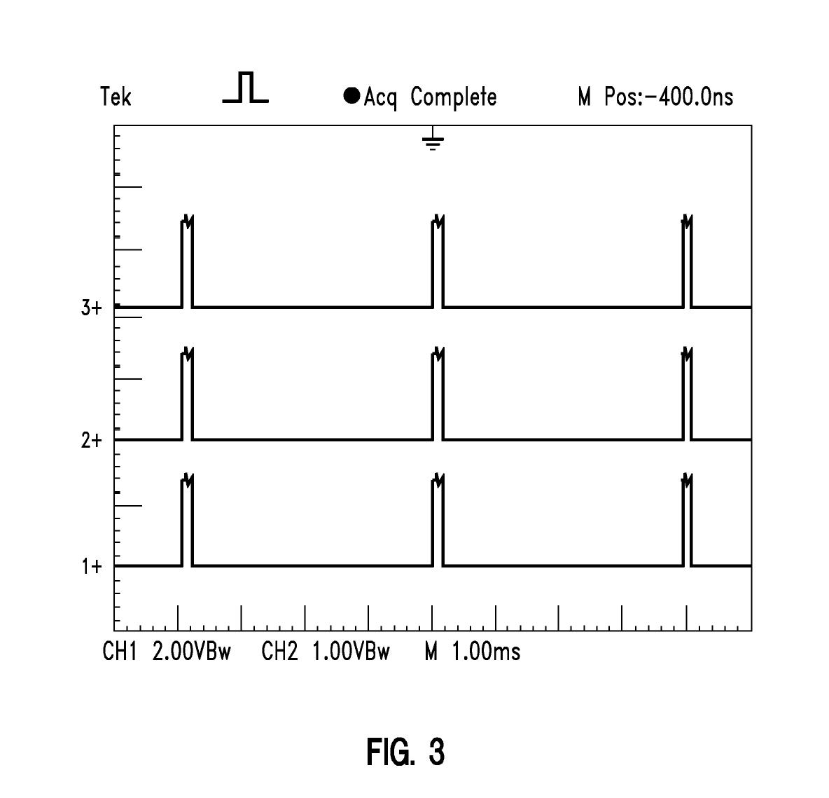

Tests were performed to insure that several distinct wireless sensors, using the described methods, would maintain synchronous sampling over extended periods of time. In this test, three sensor nodes were connected to differential strain gauges and set into a 256 Hz synchronized sampling mode. An oscilloscope was used to capture square pulses, as shown in FIG. 3, marking the start of a sample on each of the three sensors.

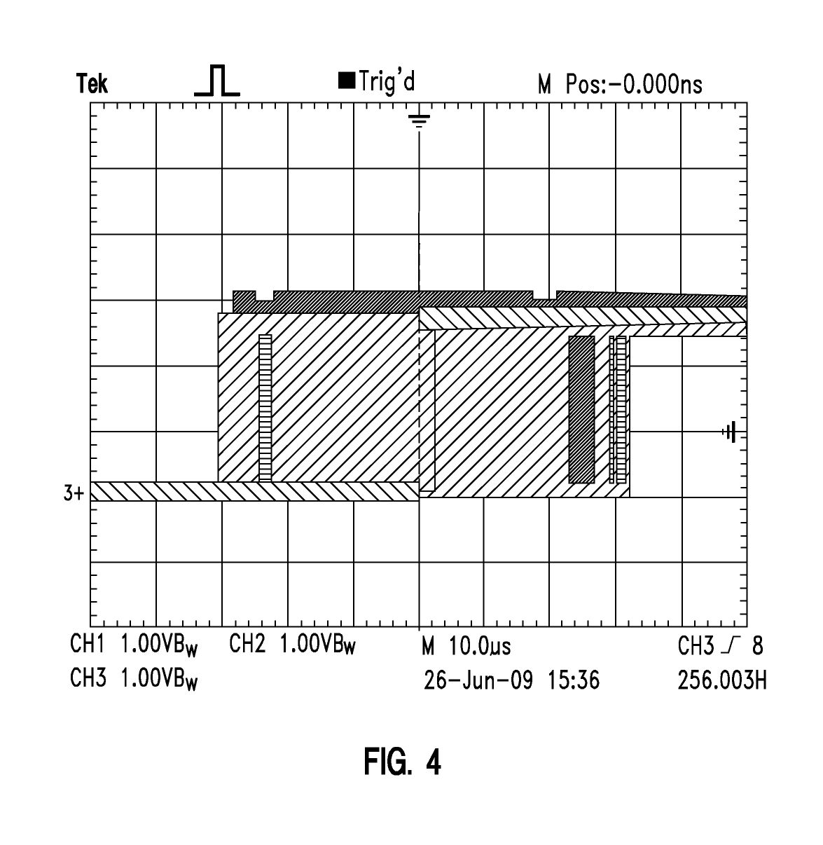

Additional synchronization tests were performed using this setup in order to gain a more accurate impression of the relative time drift. In this test, the start-of-sample pulses from each of the three nodes were collected over one hour using the persistent graphing mode of a multi-channel oscilloscope, thus creating a drift envelope as shown in FIG. 4. With a data acquisition rate of 256 samples/sec, this results in 921,600 total samples per sensor. Results from this test yielded a relative time drift of +/−30 microseconds, as shown by the envelope of start of sample pulses displayed in the screen capture in FIG. 4 consistent with expectations for the repeated beacon synchronizations at 20 second intervals.

### Secondary Clock to Fine Tune Synchronization

In the case described above, the sensor nodes were using a 32 kHz RTC as both a wakeup and sampling timer. As described in the previous section, this allowed a best case synchronization accuracy of +/−1/32 kHz, or about +/−30 us.

We can increase this accuracy by using a faster secondary clock to “fine-tune” sampling synchronization. This works as follows: when the beacon is received, the RTC counter is set to the designated value and the secondary clock is started. The secondary clock runs at a high speed, such as 20 Mhz. The secondary clock allows measurement of the time between the arrival of the beacon and the next 32 kHz tick of the RTC. The value of this measured offset is stored on the node, allowing for adjustment of each subsequent sampled data timestamp. The resolution of this secondary timer can be sub-microsecond. In this example, its resolution is 1/20 microsecond. Using this method the resolution of the sampling time stamp can be much greater than the resolution of the wake up timer. The system clock of the microprocessor can provide the secondary clock. Use of the secondary clock does not affect power consumption adversely since the microprocessor is already awake to acquire the beacon, and its system clock is therefore running anyway.

In another embodiment, for RTCs for which the frequency can be adjusted, such as the ISL12020M from Intersil, the measurement of the secondary clock is used to measure the delay between arrival of the beacon and the next tick of the RTC counter. Then the frequency of the RTC counter is adjusted in view of that measured time. When this is done in each wireless sensor node, the frequency of the RTCs in all the wireless sensor nodes are all synchronized to within the resolution of the secondary clock at the instant they were updated.

Each RTC has onboard memory or registers that contain values that determine the mode of operation of the RTC, including the frequency of the RTC. By changing these values the frequency can be adjusted. The values are determined based on calculation from the measurement of the desired frequency change.

While the RTCs in the various wireless sensor nodes then gradually drift apart over time the synchronization of the RTCs is repeated with each beacon. For example, if the beacon is provided at a frequency of once per second, the period at which synchronization is thus restored is once per second. For clocks that have a frequency accuracy of +/−3 ppm two nodes could only drift apart by as much as 6 microseconds between beacons.

Using this method, the accuracy of synchronization is limited only to the tolerance of the RTC and the rate of re-synchronizations. Given an RTC with +/−3 ppm and beacon update rate of 1 second, discrete sensor nodes will exhibit synchronized sampling to within +/−3 micro seconds of the beacon.

In one embodiment, to facilitate data collection and time synchronization from arrays of sensing nodes, a data aggregation node, such as WSDA® Wireless Sensor Data Aggregator™ or base station, termed the WSDA®-Base-mXRS™ Wireless Base Station, both available from MicroStrain Inc., Williston, Vt., were developed that was capable of data collection from both wired and wireless sensor networks. The arrays of sensing nodes, including strain sensors, were mounted to a Bell M412 helicopter. Precision time keepers within each node were synchronized by broadcasting a timing reference from the WSDA to all the networked nodes.

The WSDA used the Global Positioning System (GPS) as its timing reference.

The WSDA was responsible for data collection and timing management within the wireless sensor network. The WSDA features a GPS receiver, timing engine, microprocessor core running Linux 2.6, CAN bus controller, and wireless controller. It provides large on board data storage, as well as an Ethernet, Bluetooth, or cell link used to direct data to an online database.

While each wireless node could synchronize to the GPS more power would be consumed than by having a single base station or wireless sensor data aggregator that receives the GPS signal and then transmits a beacon. In this embodiment, the wireless sensor nodes do not need their own GPS radio.

The wireless nodes included strain gauges, accelerometers, load/torque cells, thermocouples, and RFIDs. Data were collected at multiple sampling rates and time stamped and aggregated within a single SQL database on the WSDA

Thus, the WSDA, in addition to providing a central location for collecting data, also provided a beaconing capability to synchronize each sensor node's embedded precision timekeeper. Wireless node network initial synchronization in response to a centrally broadcast network command, such as to initiate node sampling, or to synchronize node time keepers, was measured at +/−4 microseconds.

### Transmission Scheduling

Data was time-stamped and then buffered for a short duration before transmission. By buffering, as opposed to transmitting data after each sample, we allowed the sensors to save power on radio start-up and packet overhead. In addition, we granted versatility to the network in organizing transmission times such that many wireless sensor nodes may transmit data on the same radio channel without interfering with one another.

Time Division Multiple Access (TDMA) was used to avoid transmission collisions and maximize the number of wireless sensors supported by one base station. This method allots a unique time slot to each sensor node in the network. The sensor may transmit data only within its allotted period of time, assuring that no collisions will occur.

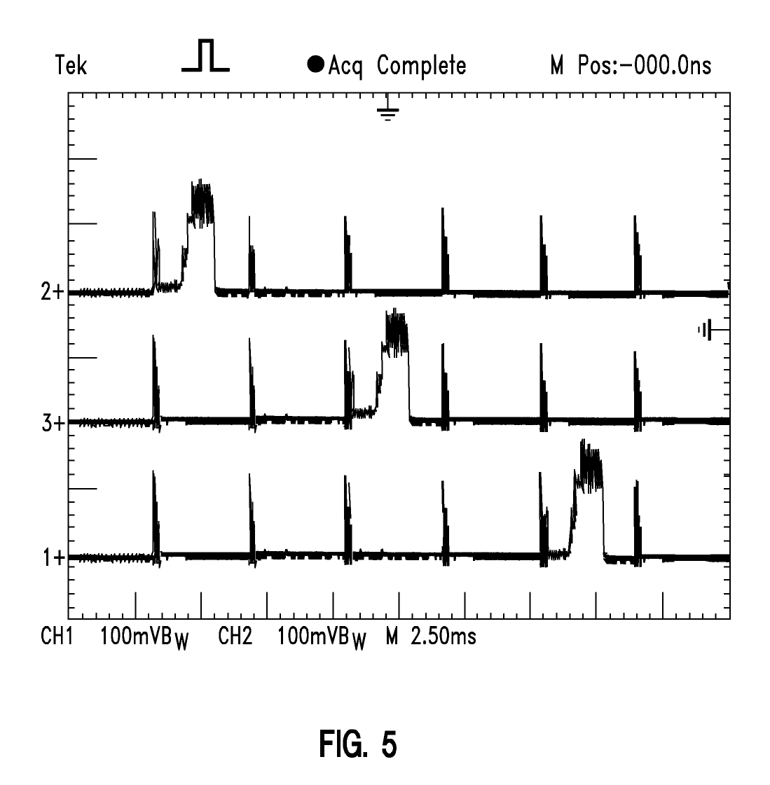

Tests were performed to verify time division stability over an extended period of time. The oscilloscope capture in FIG. 5 displays three sensors operating in a synchronized network while utilizing a TDMA transmission scheme. In this case, the shorter duration spikes represent sensor samples occurring at 256 Hz, while the longer duration pulses represent transmissions. These sensors were set to maintain TDMA locations at a distance of two sampling periods (or two time slots) apart from each other.

For our network, it was decided that time slots should remain a fixed size, while transmission frequency would vary based on sampling rate and the number of active sensor channels. In this way, sensor nodes using different configurations may be easily supported within the same network. The time slot size was selected to be 1/256, or about 3.9 ms. This size slot allowed sufficient time for the transmission duration, with enough buffer before the next time slot to allow for an acknowledgment.

### Error Correction

In one embodiment, the base station was configured to automatically recognize corrupted or missing data through inaccuracies in either of these values. The base station quickly responded to each packet it received with either an acknowledgment of successful delivery or a request for retransmitted data.

In addition to a time slot dedicated to data transmission, each sensor was also allocated a time slot for retransmissions. In the case of lost or bad data, the wireless node temporarily stores the data into a buffer until retransmission is allowed.

### Scalability

Each base station may support a variable number of sensors based on the required bandwidth of each sensor node. A node's bandwidth is dependent on its sampling rate and number of utilized sensor channels, which determine how many time slots per second it will require to get all its data across. In the case that all nodes are utilizing error correction through retransmission, the required bandwidth doubles for each. The table below gives the real-world associated “bandwidth” for each node as a percent of the total bandwidth, taking into consideration error correction. For example, this model shows that a network 3-channel wireless sensor nodes sampling at 256 Hz and supporting error correction may currently support 32 wireless sensor nodes, or 96 separate strain gauges.

Frequency Division Multiple Access (FDMA) allows the aggregate capacity of a local network to expand linearly with additional frequency channels. Multiple base stations may be synchronized through the same source, and each operate a family of sensors on a unique frequency channel (FDMA). For example, expanding the network to incorporate just 8 base stations on separate frequency channels would expand the capacity of the network to 256 synchronized sensor nodes, each sampling 3 strain gauges at 256 Hz.

### Energy Harvesting

A network of synchronized, energy harvesting wireless sensors was developed for tracking aircraft structural load. Testing revealed that the sensors successfully synchronized sampling and transmission timing while performing real-time error correction. The system demonstrated that it is scalable to support several distinct sensor nodes utilizing a variable arrangement of sensors and sampling rates. In addition, under typical helicopter operating conditions, the sensor nodes accomplished sample rates up to 512 Hz while still consuming less power than the amount of energy harvested.

While the disclosed methods and systems have been shown and described in connection with illustrated embodiments, various changes may be made therein without departing from the spirit and scope of the invention as defined in the appended claims.

1. A method of sampling data, comprising:
a. providing a plurality of wireless nodes, wherein each said wireless node includes a receiver, real time clock and a counter, wherein ticks of said real time clock are counted by said counter;
b. broadcasting a common beacon for receipt by receivers of each of said wireless nodes; and
c. upon receipt of said common beacon setting each of said counters to a first preset value.

2. A method as recited in claim 1, wherein each said wireless node includes a processor, wherein said processor includes said counter.

3. A method as recited in claim 2, wherein said processor includes a sleep mode and an awake mode, further comprising waking said processor from said sleep mode simultaneously in each of said plurality of wireless nodes.

4. A method as recited in claim 1, wherein each said wireless sensor node includes a sensor, further comprising sampling data with said sensor when said counter reaches a preset sensor-counter value.

5. A method as recited in claim 1, wherein each said wireless node includes a sensor, further comprising sampling data with said sensor simultaneously in each of said plurality of wireless nodes.

6. A method as recited in claim 5, wherein said sensor includes at least one from the group consisting of a strain sensor, a vibration sensor, a load cell, a torque sensor, a pressure sensor, and an accelerometer.

7. A method as recited in claim 1, wherein each said wireless node includes a transceiver for transmitting sensor data and receiving said common beacon.

8. A method as recited in claim 7, further comprising transmitting from each said wireless node when said counter value reaches a preset transmission-counter value, wherein each said wireless sensor node has a different preset transmission-counter value.

9. A method as recited in claim 8, wherein said wireless node transmissions use time division multiple access transmission scheduling.

10. A method as recited in claim 8, wherein each said wireless node includes an energy harvesting device, further comprising providing energy for operating said transmitter with said energy harvesting device.

11. A method as recited in claim 7, wherein said transceiver includes at least one from the group consisting of Bluetooth, Wifi, Zigbee, Nanotron, Ethernet, Nordic, cellular link, and Ultra Wide Band (UWB).

12. A method as recited in claim 1, further comprising using error correction with each said transmission.

13. A method as recited in claim 1, further comprising providing an action counter and performing an action when said action counter reaches a preset action-counter value.

14. A method as recited in claim 13, wherein each said wireless node includes a sensor, wherein said action includes sampling data with said sensor.

15. A method as recited in claim 1, wherein each of said wireless nodes further comprises a secondary timer, further comprising using said secondary timer to determine the magnitude of the synchronization error between wireless nodes.

16. A method as recited in claim 15, wherein said real time clock has an adjustable frequency, further comprising using said secondary timer to adjust said frequency of said real time clock.

17. A method of performing an action, comprising:
a. providing a plurality of wireless nodes, wherein each said wireless node includes a receiver and a real time clock;
b. broadcasting a common beacon and synchronizing said real time clocks in each of said wireless nodes based on said beacon; and
c. simultaneously performing an action by each said wireless node wherein timing in each wireless node is determined by said synchronized real time clock.
